(19) United States
(12) Patent Application Publication
(10) Pub. No.: US 2007/0189847 A1
(43) Pub. Date: Aug. 16, 2007

(54) Quick release device for extension rod

(76) Inventor: Chang Chuan Lee, Nantou (TW)

Correspondence Address: CHANG CHUAN LEE, P.O. BOX 2103, TAICHUNG, TW

(21) Appl. No.: 11/354,816

(22) Filed: Feb. 16, 2006

(51) Int. Cl. B25G 3/18

(52) U.S. Cl. 403/322.1

(57) ABSTRACT

A quick release device for an extension rod includes a radial hole and an engaging hole respectively defined in the body and a side of the head of the extension rod. The radial hole and the engaging hole communicate with an axial recess defined in a distal end of the head. An activation rod is movably received in the axial recess and is connected to a push rod movably extends through the radial hole. A biasing member is biased between the push rod and a closed end of the axial recess. A bead is movably engaged with the engaging hole and in contact with stepped surface on the other end of the push rod. A sleeve member is movably mounted on the body and connected with two ends of the push rod so that when pulling the sleeve member, the activation rod is moved and the bead moves in the engaging hole.

### FIELD OF THE INVENTION

The present invention relates to a quick release device for extension rod so as to secure the socket connected to the extension rod and to release the socket quickly.

### BACKGROUND OF THE INVENTION

A conventional quick release device for releasing socket from an extension rod is shown in FIG. 7 and generally includes a radial recess 72 defined in a head portion 71 of an extension rod 7 and a spring 721 is received in the radial recess 72 and a bead 722 is partially received in the radial recess 72 and biased by the spring 721. A socket 8 includes an engaging recess defined in an end thereof and a notch 811 is defined in an inner periphery of the engaging recess so that when the socket 8 is mounted to the head portion 71 of the extension rod 7, the bead 722 is engaged with notch 811 to position the socket 8 on the head portion 71. The specification of the spring 721 has to be carefully chosen because if the spring force is too strong, the socket 8 is difficult to be removed from the extension rod 7, on the contrary, if the spring force is not strong enough, the socket 8 might be disengaged from the head portion 71 easily.

The present invention intends to provide a quick release device for an extension rod and the device includes a sleeve member connected with a push rod which pushes an activation rod with stepped surfaces to move the bead. The bead can be firmly pushed between the stepped surfaces and the socket.

### SUMMARY OF THE INVENTION

The present invention relates to an extension rod for being connected with sockets, the extension rod comprises a tubular body and a head connected to an end of the body. An axial recess is defined in a distal end of the head and a radial hole and an engaging hole are defined in the body and a side of the head. The radial hole and the engaging hole communicate with the axial recess. An activation rod is movably received in the axial recess and has a connection end and a push end.

A push rod movably extends through the radial hole and is smaller than the radial hole. The push rod is connected with the connection end of the activation rod. Two ends of the push rod extend beyond outside of the body and are connected with a sleeve member which is movably mounted on the body. A biasing member is received in the axial recess and biased between the push rod and an end of the axial recess. A bead is movably engaged with the engaging hole and in contact with the push end of the push rod.

The bead moves up and down in the engaging hole when moving the sleeve member to move the activation rod, such that a socket mounted on the head of the body can be secured in position or released from the head.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the extension rod and the quick release device of the present invention;

FIG. 2 is a cross sectional view to show a socket is secured on the extension rod of the present invention;

FIG. 3 is a cross sectional view to show that the bead is lowered when the activation rod is pulled by moving the sleeve member of the quick release device of the present invention;

FIG. 4 is an exploded view to show the other embodiment of the extension rod and the quick release device of the present invention;

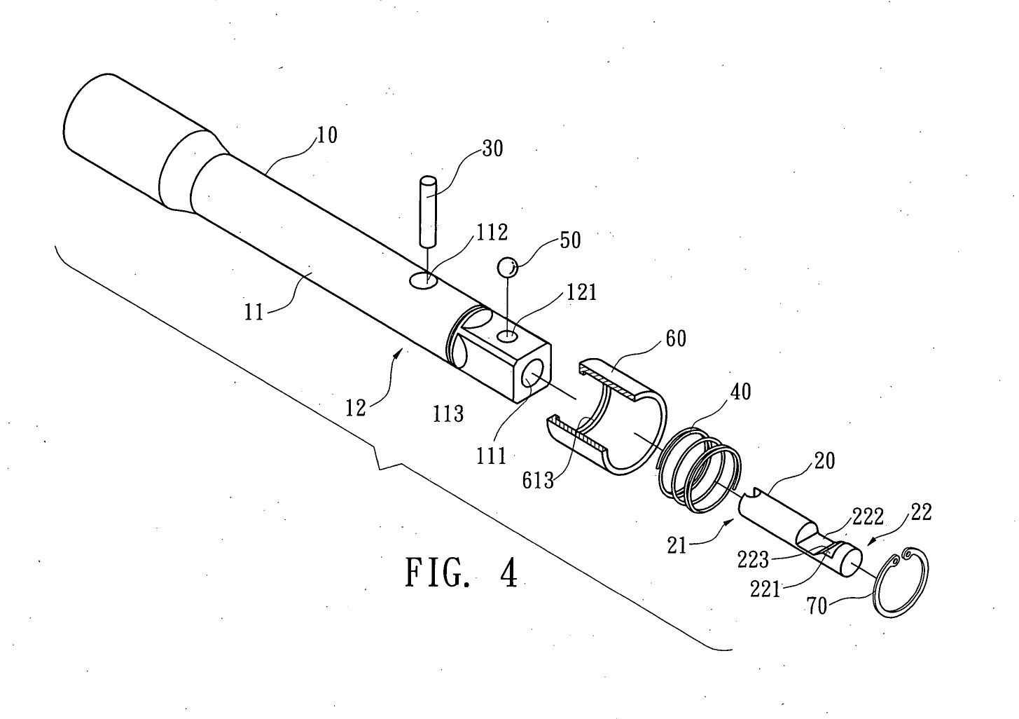

FIG. 5 is a cross sectional view to show a socket is secured on the extension rod of the present invention in FIG. 4;

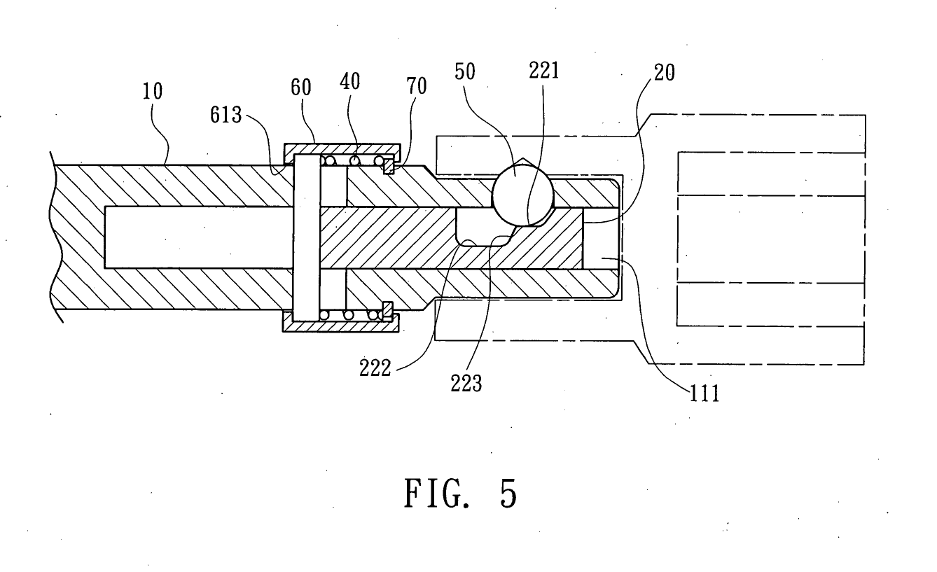

FIG. 6 is a cross sectional view to show that the bead is lowered when the activation rod is pulled by moving the sleeve member of the quick release device of the present invention in FIG. 4, and

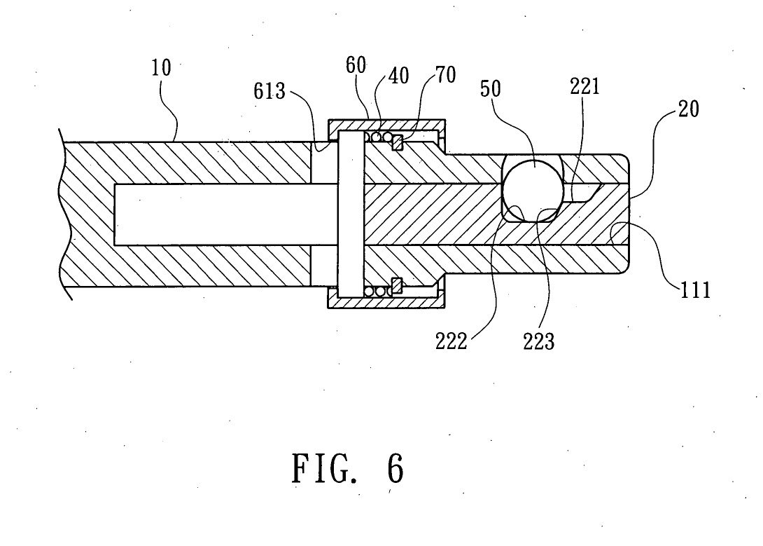

FIG. 7 is a cross sectional view of a conventional quick release device for securing a socket on an extension rod.

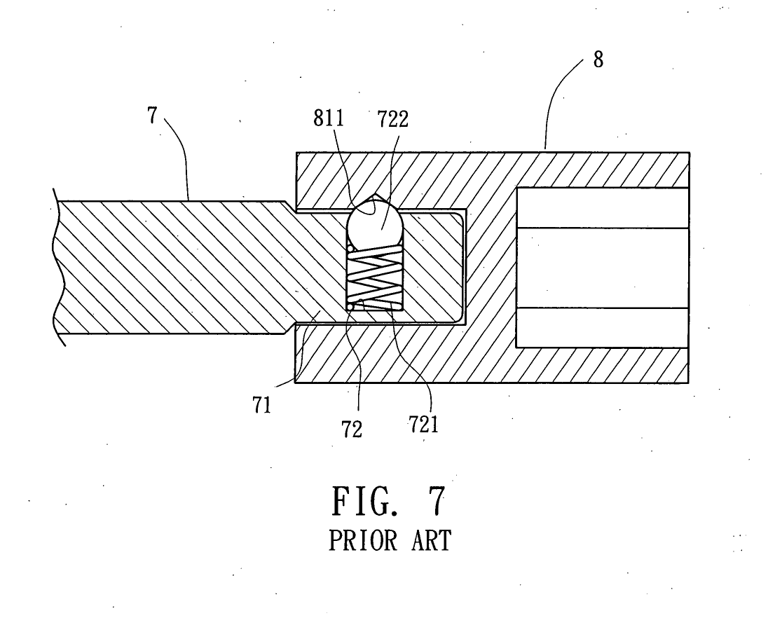

### DETAILED DESCRIPTION OF THE PREFERRED EMBODIMENT

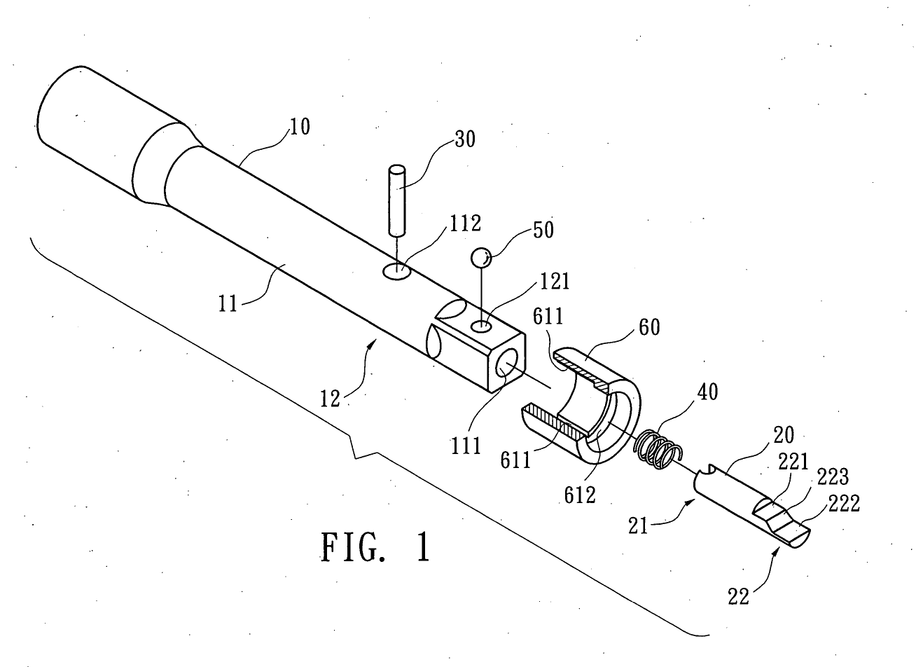

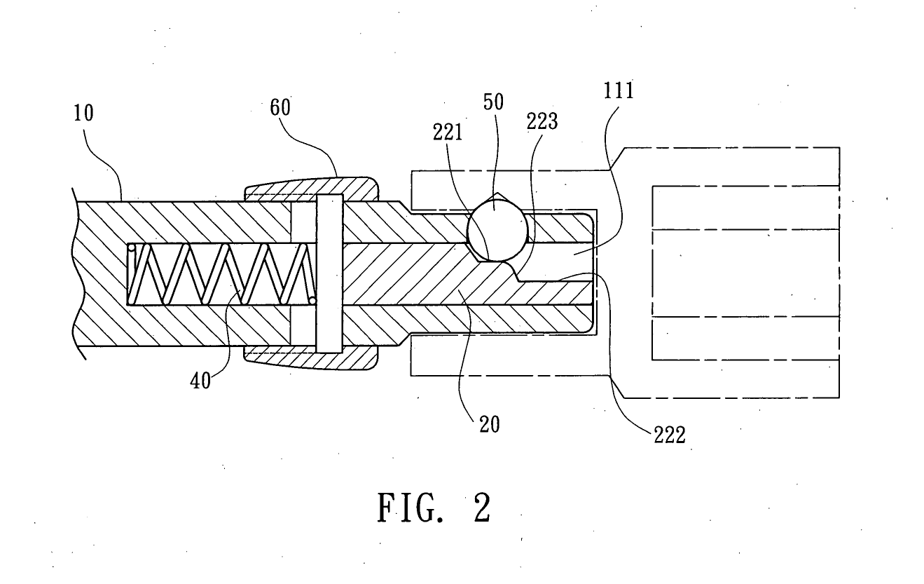

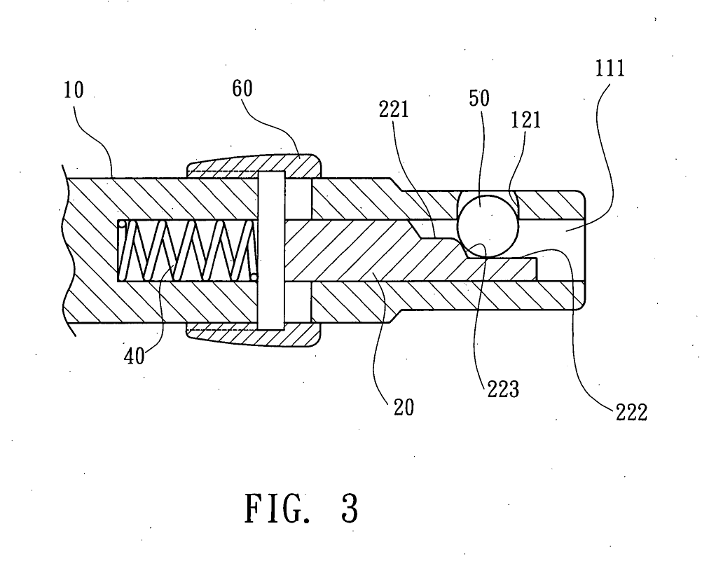

Referring to FIGS. 1 to 3, the extension rod 10 of the present invention comprises a tubular body 11 and a head 12 connected to an end of the body 11. an axial recess 111 defined in a distal end of the head 12 and a radial hole 112 defined through the body 11, the radial hole 112 communicating with the axial recess 111, an engaging hole 121 defined in a side of the head 12 and communicating with the axial recess 111;

an activation rod 20 movably received in the axial recess 111 and having a connection end 21 and a push end 22;

a push rod 30 movably extending through the radial hole 112 and being smaller than the radial hole 112, the push rod 30 connected with the connection end 21 of the activation rod 20, two ends of the push rod 30 extending beyond outside of the body 11;

a biasing member 40 received in the axial recess 111 and biased between the push rod 30 and a closed end of the axial recess 111;

a bead 50 movably engaged with the engaging hole 121 and in contact with the push end 22 of the push rod 20, and

a sleeve member 60 movably mounted on the body 11 and the two ends of the push rod 20 connected to the sleeve member 60.

2. The combination as claimed in claim 1, wherein the connection end 21 of the activation rod 20 includes a groove with which the push rod 30 is engaged.

3. The combination as claimed in claim 1, wherein the push end 22 of the activation rod 20 includes stepped surfaces which includes a first step surface 221 and a second step surface 222, an inclined surface 223 connected between the first and second step surfaces 221, 222.

4. The combination as claimed in claim 1, wherein the sleeve member 60 includes two axial keyways 611 and an engaging groove 612 defined in an inner periphery thereof, the two ends of the push rod 30 slide into the two axial keyways 611 and are engaged with the engaging groove 612.

5. The combination as claimed in claim 1, the biasing member 40 is a spring.

6. A combination of a quick release device and an extension rod 10 for being connected with sockets, comprising:

a tubular body 11 and a head 12 connected to an end of the body 11, an axial recess 111 defined in a distal end of the head 12 and a radial hole 112 defined through the body 11, the radial hole 112 communicating with the axial recess 111, an engaging hole 121 defined in a side of the head 12 and communicating with the axial recess 111;

an activation rod 20 movably received in the axial recess 111 and having a connection end 21 and a push end 22;

a push rod 30 movably extending through the radial hole 112 and being smaller than the radial hole 112, the push rod 30 connected with the connection end 21 of the activation rod 20, two ends of the push rod 30 extending beyond outside of the body 11;

a biasing member 40 mounted on the body 11 and an end of the biasing member 40 contacting the two ends of the push rod 30;

a positioning member 70 mounted on the body 11 and the other end of the biasing member 40 contacting the positioning member 70;

a bead 50 movably engaged with the engaging hole 121 and in contact with the push end 22 of the push rod 20, and a sleeve member 60 movably mounted on the body 11 and the two ends of the push rod 20 connected to a first end of the sleeve member 60.

7. The combination as claimed in claim 6, wherein two flanges extend inward from the first and a second end of the sleeve member 60 such that the two ends of the push rod 20 are engaged with the flange of the first end of the sleeve member 60 and the positioning member 70 is engaged with the flange on the second end of the sleeve member 60.

8. The combination as claimed in claim 6, wherein the push end 22 of the activation rod 20 includes stepped surfaces which includes a first step surface 221 and a second step surface 222, an inclined surface 223 connected between the first and second step surfaces 221, 222.

9. The combination as claimed in claim 6, the biasing member 40 is a spring. device for of the present invention comprises a

While we have shown and described the embodiment in accordance with the present invention, it should be clear to those skilled in the art that further embodiments may be made without departing from the scope of the present invention.

What is claimed is:

1. A combination of a quick release device and an extension rod 10 for being connected with sockets, comprising:
a tubular body 11 and a head 12 connected to an end of the body 11, an axial recess 111 defined in a distal end of the head 12 and a radial hole 112 defined through the body 11, the radial hole 112 communicating with the axial recess 111, an engaging hole 121 defined in a side of the head 12 and communicating with the axial recess 111;
an activation rod 20 movably received in the axial recess 111 and having a connection end 21 and a push end 22;
a push rod 30 movably extending through the radial hole 112 and being smaller than the radial hole 112, the push rod 30 connected with the connection end 21 of the activation rod 20, two ends of the push rod 30 extending beyond outside of the body 11;
a biasing member 40 received in the axial recess 111 and biased between the push rod 30 and a closed end of the axial recess 111;
a bead 50 movably engaged with the engaging hole 121 and in contact with the push end 22 of the push rod 20, and a sleeve member 60 movably mounted on the body 11 and the two ends of the push rod 20 connected to the sleeve member 60.

2. The combination as claimed in claim 1, wherein the connection end 21 of the activation rod 20 includes a groove with which the push rod 30 is engaged.

3. The combination as claimed in claim 1, wherein the push end 22 of the activation rod 20 includes stepped surfaces which includes a first step surface 221 and a second step surface 222, an inclined surface 223 connected between the first and second step surfaces 221, 222.

4. The combination as claimed in claim 1, wherein the sleeve member 60 includes two axial keyways 611 and an engaging groove 612 defined in an inner periphery thereof, the two ends of the push rod 30 slide into the two axial keyways 611 and are engaged with the engaging groove 612.

5. The combination as claimed in claim 1, the biasing member 40 is a spring.

6. A combination of a quick release device and an extension rod 10 for being connected with sockets, comprising:
a tubular body 11 and a head 12 connected to an end of the body 11, an axial recess 111 defined in a distal end of the head 12 and a radial hole 112 defined through the body 11, the radial hole 112 communicating with the axial recess 111, an engaging hole 121 defined in a side of the head 12 and communicating with the axial recess 111;
an activation rod 20 movably received in the axial recess 111 and having a connection end 21 and a push end 22;
a push rod 30 movably extending through the radial hole 112 and being smaller than the radial hole 112, the push rod 30 connected with the connection end 21 of the activation rod 20, two ends of the push rod 30 extending beyond outside of the body 11;
a biasing member 40 mounted on the body 11 and an end of the biasing member 40 contacting the two ends of the push rod 30;
a positioning member 70 mounted on the body 11 and the other end of the biasing member 40 contacting the positioning member 70;
a bead 50 movably engaged with the engaging hole 121 and in contact with the push end 22 of the push rod 20, and a sleeve member 60 movably mounted on the body 11 and the two ends of the push rod 20 connected to a first end of the sleeve member 60.

7. The combination as claimed in claim 6, wherein two flanges extend inward from the first and a second end of the sleeve member 60 such that the two ends of the push rod 20 are engaged with the flange of the first end of the sleeve member 60 and the positioning member 70 is engaged with the flange on the second end of the sleeve member 60.

8. The combination as claimed in claim 6, wherein the push end 22 of the activation rod 20 includes stepped surfaces which includes a first step surface 221 and a second step surface 222, an inclined surface 223 connected between the first and second step surfaces 221, 222.

9. The combination as claimed in claim 6, the biasing member 40 is a spring.
